(19) United States
(12) Patent Application Publication
(10) Pub. No.: US 2023/0019393 A1
(43) Pub. Date: Jan. 19, 2023

(54) SEALING STRUCTURE OF HUMIDIFIER

(71) Applicant: Shenzhen Extender Co., Ltd., Shenzhen (CN)

(72) Inventors: Zhaohui WEN, Shenzhen (CN); Yiming SHI, Shenzhen (CN); Yan FENG, Shenzhen (CN); Chao LIU, Shenzhen (CN)

(73) Assignee: Shenzhen Extender Co., Ltd., Shenzhen (CN)

(21) Appl. No.: 17/864,445

(22) Filed: Jul. 14, 2022

(30) Foreign Application Priority Data
Jul. 15, 2021 (CN) 202121609262.X

(51) Int. Cl. F16J 15/06; F24F 6/12; F16J 15/10

(52) U.S. Cl. CPC F16J 15/062; F24F 6/12; F16J 15/061; F16J 15/102

(57) ABSTRACT

A sealing structure of a humidifier includes a main structure, a left end cover, and a right end cover. The left end cover and the right end cover are arranged on left and right end faces of the main structure, respectively. A dry air inlet tube is connected to a top end face of the left end cover, and a dry air outlet tube is connected to a top end face of the right end cover. A wet air outlet tube and a wet air inlet tube are connected to left and right sides of a top end face of the main structure, respectively. Membrane tubes are arranged on an inner side of the main structure. Potting resin layers are arranged on both ends of the membrane tubes. High-temperature resistant sealant layers are arranged at connecting portions between each end cover and the main structure.

### CROSS REFERENCE TO THE RELATED APPLICATIONS

This application is based upon and claims priority to Chinese Patent Application No: 202121609262.X, filed on Jul. 15, 2021, the entire contents of which are incorporated herein by reference.

### TECHNICAL FIELD

The present disclosure relates to the technical field of hydrogen fuel cells, in particular, to a sealing structure of a humidifier.

### BACKGROUND

Hydrogen fuel cells are equivalent to power generating devices capable of directly converting the chemical energy of hydrogen and oxygen into electrical energy. The basic principle of the hydrogen fuel cells is based on the reverse reaction of water electrolysis. That is, the hydrogen and the oxygen are respectively supplied to an anode and a cathode. The hydrogen diffuses outwards through the anode to react with an electrolyte. In this way, electrons are released and reach the cathode through an external load. Specifically, H₂ in a gaseous form passes through a diffusion layer, which is made from carbon fibers, of the anode and is separated into H protons and electrons in a catalyst layer of the anode. The H protons (in the state of H₃O+) pass through a proton exchange membrane and are combined with O ions in a catalyst layer of the cathode to generate water. Theoretically, the proton exchange membrane can only allow the protons to pass through, a great many sulfonic groups exist in the proton exchange membrane, and a high proton conductivity can be achieved only in a wet state. In general, the hydrogen at the anode and air at the cathode are necessary to humidify. Water is generated from the reaction on a cathode side and can migrate to an anode side through the membrane due to the gradient difference of concentrations of water on the cathode side and the anode side. Therefore, humidifiers are needed. Most existing humidifiers on the market are sealed with silicone rings. In this method, the silicone rings need to be customized, and the risk of air leakage exists. In view of this, a sealing structure for the humidifiers is put forward in this disclosure to solve the above problems.

### SUMMARY

The objective of the present disclosure is to provide a sealing structure of a humidifier to solve the problems mentioned in the background.

To achieve the above objective, the present disclosure provides the following solution:

A sealing structure of a humidifier includes a main structure, a left end cover, and a right end cover. The left end cover is arranged on a left end face of the main structure, and a dry air inlet tube is connected to a top end face of the left end cover. The right end cover is arranged on a right end face of the main structure, and a dry air outlet tube is connected to a top end face of the right end cover. A wet air outlet tube is connected to a left side of a top end face of the main structure, and a wet air inlet tube is connected to a right side of the top end face of the main structure. Membrane tubes are arranged on an inner side of the main structure. Potting resin layers are arranged on both ends of the membrane tubes. High-temperature resistant sealant layers are arranged at a connecting portion between the left end cover and the main structure and a connecting portion between the right end cover and the main structure.

Preferably, a front view of the left end cover and a front view of the right end cover are both in the shape of an inverted trapezoid.

Preferably, a plurality of membrane tubes is evenly distributed on the inner side of the main structure.

Preferably, an outer surface of the main structure and an inner surface of each of the left end cover and the right end cover are each provided with a reinforcing rib.

Preferably, the left end cover and the main structure as well as the right end cover and the main structure are fixedly connected by means of a bolt.

Compared with the prior art, the present disclosure has the following beneficial effects:

By means of the high-temperature resistant sealant layers, the connecting portions can be filled effectively. In this way, air on a dry side cannot leak to a wet side, thereby avoiding the risk of air leakage between the dry side and the wet side.

### BRIEF DESCRIPTION OF THE DRAWINGS

FIG. 1 is an overall structural diagram of a sealing structure of a humidifier of the present disclosure.

FIG. 2 is a sectional view of the sealing structure of a humidifier of the present disclosure.

Reference numerals: 1. main structure, 2. left end cover, 3. right end cover, 4. dry air inlet tube, 5. dry air inlet tube, 6. wet air outlet tube, 7. wet air inlet tube, 8. membrane tube, 9. potting resin layers, 10. high-temperature resistant sealant layer.

### DETAILED DESCRIPTION OF THE EMBODIMENTS

The technical solutions in embodiments of the present disclosure will be described below clearly and completely with reference to the accompanying drawings in the embodiments of the present disclosure. It will become apparent that the described embodiments are merely a part, rather than all of the embodiments of the present disclosure. All other embodiments obtained by a person of ordinary skill in the art based on the embodiments of the present disclosure without creative efforts shall fall within the protection scope of the present disclosure.

It should be noted that the terms used herein are merely used for describing the specific implementations but are not intended to limit the exemplary implementations of the present application. As used herein, the singular forms are intended to include the plural forms as well unless the context clearly indicates otherwise. Also, it should be understood that when the terms “include” and/or “comprise” are used in this specification, they indicate that there may be features, steps, operations, devices, elements, and/or combinations thereof other than those recited.

Unless otherwise specified, the relative arrangement, numerical expressions, and numerical values of components and steps set forth in these embodiments do not limit the scope of the present disclosure. Meanwhile, it should be understood that for ease of description, each portion in the accompanying drawings is not necessarily drawn to the actual scale. The technologies, methods, and equipment known to those of ordinary skill in the art may not be discussed in detail, but where appropriate, the technologies, methods, and equipment should be regarded as part of the specification. In all examples shown and discussed herein, any specific features should be interpreted as merely exemplary, rather than restrictive. Therefore, other examples of the exemplary embodiments may have different features. It should be noted that similar reference signs and letters represent similar items in the accompanying drawings below. Therefore, once an item is defined in one drawing, it does not need to be further discussed in subsequent drawings.

It should be understood that, in the description of the present disclosure, terms such as “front”, “rear”, “upper”, “lower”, “left”, “right”, “transverse”, “longitudinal”, “vertical”, “horizontal”, “top” and “bottom” indicate orientation or position relationships based on the accompanying drawings. Unless otherwise specified, these terms are merely intended to facilitate or simplify the description of the present disclosure, rather than to indicate or imply that the mentioned device or components must have a specific orientation and must be constructed and operated in a specific orientation. Therefore, they should not be construed as a limitation to the protection scope of the present disclosure. The orientation terms “inner” and “outer” refer to the inner and outer parts relative to the contour of the mentioned component.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

In addition, it must be noted that the use of such words as “first” and “second” to define components is merely intended to distinguish the corresponding components. Unless otherwise stated, such words have no special meaning and thus should not be construed as limiting the protection scope of the present disclosure.

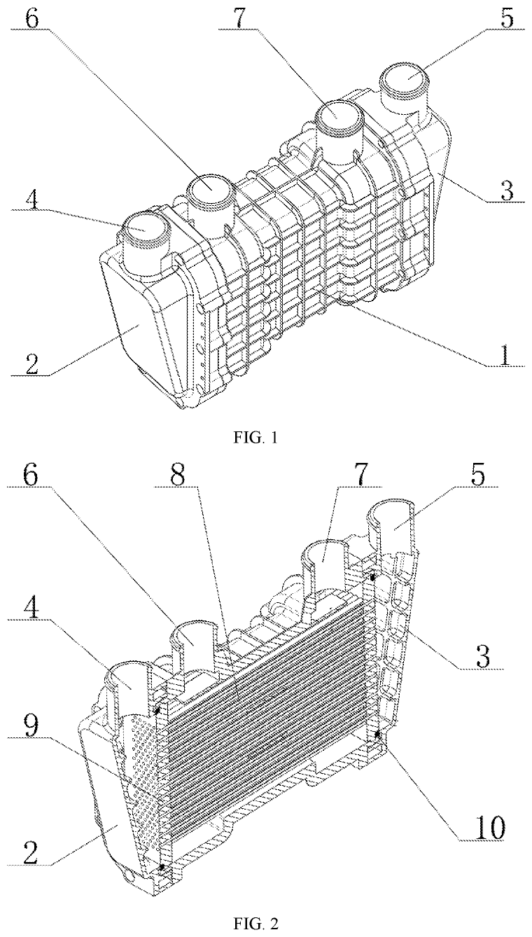

Referring to FIG. 1 and FIG. 2, the present disclosure provides the following technical solution.

A sealing structure of a humidifier includes a main structure 1, a left end cover 2, and a right end cover 3. The left end cover 2 is arranged on a left end face of the main structure 1, and a dry air inlet tube 4 is connected to a top end face of the left end cover 2. The right end cover 3 is arranged on a right end face of the main structure 1, and a dry air outlet tube 5 is connected to a top end face of the right end cover 3. A wet air outlet tube 6 is connected to a left side of a top end face of the main structure 1, and a wet air inlet tube 7 is connected to a right side of the top end face of the main structure 1. Membrane tubes 8 are arranged on an inner side of the main structure 1. Potting resin layers 9 are arranged on both ends of the membrane tubes 8. High-temperature resistant sealant layers 10 are arranged at a connecting portion between the left end cover 2 and the main structure 1 and a connecting portion between the right end cover 3 and the main structure 1, so that the connecting portions can be filled effectively. In this way, air on a dry side does not leak to a wet side, thereby avoiding the risk of air leakage between the dry side and the wet side.

A front view of the left end cover 2 and a front view of the right end cover 3 are both in the shape of an inverted trapezoid, so that air flowing is facilitated. A plurality of membrane tubes 8 is evenly distributed on the inner side of the main structure 1, so that a good wet environment is formed, facilitating heat exchange. An outer surface of the main structure 1 and an inner surface of each of the left end cover 2 and the right end cover 3 are each provided with reinforcing ribs so that quality of the device is guaranteed. The left end cover 2 and the main structure 1 as well as the right end cover 3 and the main structure 1 are fixedly connected by means of bolts so that the convenience for assembly and disassembly is achieved.

An operating process is as follows: The structure is composed of the main structure 1, the left end cover 2, the right end cover 3, the membrane tubes 8, the potting resin layers 9, and the high-temperature resistant sealant layers 10. The membrane tube 8 is arranged on the inner side of the main structure 1. The potting resin layer 9 is encapsulated on both sides of the membrane tubes 8 and both sides of the main structure 1. Wet air from a galvanic pile enters the main structure 1 via the wet air inlet tube 7 on the right side of the top end face of the main structure 1, flows outside the membrane tube 8, and exits from the main structure 1 via wet air outlet tube 6 on the left side of the top end face of the main structure 1. Dry air enters the main structure 1 via the dry air inlet tube 4 on the left end cover 2, flows inside the membrane tube 8 to be subjected to heat exchange with the wet air outside the membrane tube 8, and then exits from the main structure 1 via the dry air outlet tube 5 on the right end cover 3 and enters the galvanic pile. The connecting portions on both sides of the main structure 1 are provided with grooves filled with the high-temperature resistant sealant layers 10. The high-temperature resistant sealant layers 10 are tightly pressed by annular protrusions on the end covers. The potting resin layer 9 and the main structure 1 made from different materials have different expansion coefficients, and thus separate from each other at a high temperature or a low temperature. In this case, the high-temperature resistant sealant layer 10 functions to connect the potting resin layer 9 and the main structure 1. In this way, the air on the dry side cannot leak to the wet side, thereby avoiding a risk of air leakage between the dry side and the wet side is eliminated.

Although the embodiments of the present disclosure have been illustrated and described above, those of ordinary skill in the art can understand that various changes, modifications, replacements, and alterations may be made to these embodiments without departing from the principles of the present disclosure, and the scope of the present disclosure is defined by the claims and equivalents thereof.

What is claimed is:

1. A sealing structure of a humidifier, comprising a main structure, a left end cover, and a right end cover, wherein the left end cover is arranged on a left end face of the main structure, and a dry air inlet tube is connected to a top end face of the left end cover; the right end cover is arranged on a right end face of the main structure, and a dry air outlet tube is connected to a top end face of the right end cover; a wet air outlet tube is connected to a left side of a top end face of the main structure, and a wet air inlet tube is connected to a right side of the top end face of the main structure; a plurality of membrane tubes is arranged on an inner side of the main structure; potting resin layers are arranged on both ends of the plurality of membrane tubes; and high-temperature resistant sealant layers are arranged at a connecting portion between the left end cover and the main structure and a connecting portion between the right end cover and the main structure.

2. The sealing structure of the humidifier according to claim 1, wherein a front view of the left end cover and a front view of the right end cover are both in a shape of an inverted trapezoid.

3. The sealing structure of the humidifier according to claim 1, wherein the plurality of membrane tubes is evenly distributed on the inner side of the main structure.

4. The sealing structure of the humidifier according to claim 1, wherein an outer surface of the main structure and an inner surface of each of the left end cover and the right end cover are each provided with a reinforcing rib.

5. The sealing structure of the humidifier according to claim 1, wherein the left end cover and the main structure and the right end cover and the main structure are fixedly connected by a bolt.
